(19) United States
(12) Patent Application Publication
(10) Pub. No.: US 2010/0308647 A1
(43) Pub. Date: Dec. 9, 2010

(54) Power Supply Circuit for a Vehicle

(75) Inventors: Sven Fluhrer, Horb (DE); Dieter Grohmann, Gechingen (DE); Peter Herges, Stuttgart (DE); Frank Huebner, Stuttgart (DE); Alexander Lepple, Sindelfingen (DE); Tobias Raithel, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 12/440,828

(22) PCT Filed: Aug. 30, 2007
(86) PCT No.: PCT/EP2007/007577

§ 371 Date: Aug. 24, 2010

(30) Foreign Application Priority Data
Sep. 12, 2006 (DE) 10 2006 042 657.6

(51) Int. Cl. B60L 1/00

(52) U.S. Cl. 307/9.1

(57) ABSTRACT

A power supply system for a vehicle has at least one control unit with two power supply terminals that are each protected against overload by a fuse. The first power supply terminal is connected to a voltage regulator for the microcomputer of the control unit and to the accumulator via the quiescent current switch, while the second power supply terminal is connected to the accumulator via a fuse. The first power supply terminal supplies the microcomputer with energy, while the second power supply terminal actuates one power switch per control unit in order to supply energy to the output stages of an actuator which is operated by the control unit. The on-board vehicle power system control unit activates the quiescent current switch in order to deactivate the microcomputer, while the power switches of the same control unit are supplied with power.

This application is a continuation of PCT International Application No. PCT/EP2007/007577, filed Aug. 30, 2007, which claims priority under 35 U.S.C. §119 to German Patent Application No. 10 2006 042 657.6, filed Sep. 12, 2006, the entire disclosure of which is herein expressly incorporated by reference.

### BACKGROUND AND SUMMARY OF THE INVENTION

The invention relates to a device for controlling components of a vehicle. The device has a plurality of control units which are supplied by a power supply circuit that is connected on one side to an accumulator and on the other side to the control units. Some of the control units can be switched off by means of a quiescent current switch which is connected directly into the current path between the accumulator and the control units, while another group of the control units is connected to the accumulator via the ignition/starter switch. An on-board vehicle power system control unit, which is continuously supplied with power via the accumulator, actuates the quiescent current switch and the ignition/starter switch for the switching process.

Contemporary means of transportation, for example motor vehicles and utility vehicles, have complex databus systems to which a large number of control units are connected. The control units exchange messages with one another via a databus in order to actuate the components correspondingly. Sensors and actuators are connected directly to the control units in order to make available measured values for the control units and actuate electric motors, switches and relays. In addition to the transmission of data by telecommunications via the databuses with the smallest possible current, the individual control units must be supplied with energy in order to supply current to their microcomputers, on the one hand, and to their sensors and actuators, on the other.

A serious problem in this regard is the demand for quiescent current of such databus systems: when a deactivation process for a control unit fails, the control unit continues to draw current from the vehicle battery, (that is, the accumulator), and therefore discharges the accumulator. For this reason, in addition to the ignition/starter switch, known control unit architectures have an additional quiescent current switch which disconnects the power supply line by switching off when the last control unit is powered down after the internal combustion engine has been switched off. As a result, it is impossible for current to continue to be drawn from the accumulator. The quiescent current switch galvanically separates the power supply line from the accumulator.

German patent document DE 103 30 446 A1 discloses a vehicle with networked control units which are still active in predefined run-on phases after the drive motor has been switched off. For this purpose, switching-off signals are fed to each control unit via a control line, so that the internal voltage regulator of the control unit can switch off said control unit.

German patent document DE 197 24 570 A1 discloses a control unit which switches a high power load on and off. Because of the load “jump” during the switching on and switching off process, information is transmitted in advance from the control unit to the voltage regulator in order to prevent a failure or a disruption of the voltage supply. The power requirements in the system can therefore be adapted in advance.

German patent document DE 103 12 553 B3 describes a motor vehicle with control units that are connected to energy supply lines by means of a monitoring control unit in a deactivable fashion. If the control units are powered down to a state of rest, the monitoring control unit measures the quiescent current which is actually taken up and places each control unit which deviates from the predefined quiescent current range in a reset mode. For this purpose, the current path of each control unit can be disconnected by a switching element.

German patent document DE 10 2004 054 721 A1 describes a device for reducing the quiescent current in a vehicle electronic system. A central control unit is networked to other control units via a databus. The central control unit has means for short-circuiting the databus to ground in order to initiate the quiescent state. As soon as the short circuit to ground is detected, the control units are powered down into the state of rest.

German patent document DE 100 63 753 A1 describes a voltage supply for vehicle control units, which voltage supply is powered down incrementally after the internal combustion engine has been switched off. The maintenance of the voltage (referred to as “running on”) is divided into a first and second running on phase. The engine control unit and other components are connected here to the battery via a main relay. A further voltage supply which can be switched off connects from the battery to the fuel pump via the ignition/starter switch. Voltage is applied to terminal 15 when the ignition switch is activated. Thereafter, the main relay is switched on, so that the engine control unit can be switched on. When the engine is switched off, the voltage at terminal 15 is switched off. The control pins at the control unit remain active in order to switch off the further circuit. At the end of each running on phase, a control signal is output via the control pins in order to cause the circuit to be switched off.

One object of the present invention is to provide an alternative device with a power supply circuit which can be operated with a quiescent current switch that has a lower current switching capability, compared to the known systems, and can therefore be implemented more cost-effectively.

This and other objects and advantages are achieved by the control device according to the invention, in which at least one control unit has two power supply terminals that are each protected against overload by a fuse. The first power supply terminal is connected to a voltage regulator for the microcomputer of the control unit and to the accumulator via the quiescent current switch, while the second power supply terminal is connected to the accumulator via a fuse. The first power supply terminal supplies the microcomputer with energy, while the second power supply terminal actuates one power switch per control unit in order to supply energy to the output stages of an actuator which is operated by the control unit. The on-board vehicle power system control unit activates the quiescent current switch in order to deactivate the microcomputer, while the power switches of the same control unit are supplied with power.

The inventors have determined that, by dividing the common power supply line for the individual groups of control units into a low current supply line and a high current supply line, it is possible to dispense with the costly relay as a quiescent current switch for its current switching capability. According to the invention, therefore, a low current supply line supplies power to the microcomputers of the control units, and a high current supply line operates the output stages of the actuators via the power switch in each control unit. If the control unit system is then powered down, the low current supply line is simply disconnected by the quiescent current switch, while the high current supply line remains connected directly to the accumulator. Since MOSFET power transistors (which have a very high internal resistance in the switched-off state) are generally used as power switches within the control units, additional disconnection of the power supply path by means of the quiescent current switch is unnecessary. Since only the low current supply line is disconnected by means of the quiescent current switch, the switching power of the quiescent current switch can be considerably reduced compared to the classic control unit systems.

Two types of known control unit systems, such as already currently in use in vehicles, are illustrated schematically in FIG. 1. A first control unit 1 with a microcomputer μC is supplied with power by an accumulator 12 and the quiescent current switch 13. Power is supplied to the power switch 17 within the control unit 1 in order to actuate the output-side actuator with load current. If, for example, twenty similar control units of this type are provided in the control unit system, the quiescent current switch must, in certain circumstances, switch the load current of all twenty control units. In an extreme case, this entails twenty times the maximum load current of the actuators. Such power relays for the quiescent current switch 13 are very expensive. The circuit according to the invention provides a considerable cost saving for such quiescent current switches 13 here.

FIG. 1 shows a further control unit 2 with another known quiescent current switch-off scheme. In this control unit architecture, a quiescent current switch is not provided, rather, the microcomputer μC switches itself off after it has received a signal from the on-board vehicle management control unit. This signal is a digital voltage signal which is not used as a power supply. Each of the control units of the same type has to be connected to a signal line in order to trigger the powering down of the respective control unit. Within the control unit itself, a switch is then provided which, triggered by the signal, starts software in the microcomputer. As a result, the microcomputer is deactivated and powered down into the quiescent state. This second method of switching off groups of control units requires that a separate signal line be connected from the on-board vehicle management control unit to the control units which are to be switched off.

Compared to this prior art, the device according to the invention presents an alternative control unit architecture which introduces two power supply terminals per control unit. Only the power supply line for the microcomputers is disconnected by the quiescent current switch, while the load circuits for the actuators are connected directly to the accumulator without a quiescent current switch.

In one development of the invention, the microcomputer and the power switch are arranged within the control unit on a printed circuit board, with the control electrode of the power switch being actuable directly by the microcomputer, and the two load current terminals of the power switch being led separately out of the control unit via an interface. Since the microcomputer and the power switch are arranged on a printed circuit board, the costs can be reduced further since a discrete power switch outside the control unit generates additional costs, and the multi-component nature of the system reduces reliability.

The low current supply terminal of each control unit is denoted by +C, while the power supply terminal of the load current is denoted by +P. The energy supply line +P, which is connected directly to the accumulator in an electrically conductive fashion, is provided without a quiescent current switch, while the power supply lines +C of the microcomputers are led to the quiescent current switch. In this way, the microcomputers are switched to the quiescent state, while the power switches are continuously conductively connected to the accumulator.

The on-board vehicle power system control unit controls the quiescent current switch in order to deactivate the microcomputers at a predetermined time, and can also activate a reset switch in order to actuate an additional reset supply line. Specific microcomputers can be jointly placed in a reset process via the reset supply line without the voltage regulators having to be switched off via the quiescent current switch. As a result, a controlled restart is possible in the event of a malfunction of a control unit (for example during parking maneuvers of the vehicle). Such a reset function via the reset supply line can be carried out only for specific control units, for example telematics control units or passenger compartment control units.

A control unit can then be placed into a reset mode via the reset supply line. In this context, at the engine control unit it is possible, for example, not only to carry out the reset for the engine control unit but also to switch off all the components at the engine control unit. As a result, for example in a parking situation of the vehicle, the engine control unit can be placed in a reset mode, while at the same time the actuators are deactivated. After a defined run-up mode, the engine control unit can then be restarted again in order, if appropriate, to overcome logic problems at the engine control unit.

The first power supply terminals +C of various control units can preferably be connected to the quiescent current switch via a common fuse. As a result, it is possible to dispense with fuses for the microcomputers on the low current supply line.

The power supply terminal +C is usually configured as a low current terminal for currents of less than 1 ampere since it is supplied with current via logic circuits, microcomputers and low current loads. In contrast, the load current via the high current supply terminal +P to the power transistor can be within a range of several amperes to, for example, 100 amperes, in order to actuate the actuators correspondingly.

Other objects, advantages and novel features of the present invention will become apparent from the following detailed description of the invention when considered in conjunction with the accompanying drawings.

### BRIEF DESCRIPTION OF THE DRAWINGS

FIG. 1 illustrates control unit circuit configurations according to the prior art;

FIG. 2 shows a control unit with the circuit configuration according to the invention;

FIG. 3 shows a control unit architecture with actuation of conventional control units according to the invention; and

FIG. 4 shows a control unit architecture with a low current power supply and a high current power supply of the individual control units and a reset actuation line for selected control units.

### DETAILED DESCRIPTION OF THE DRAWINGS

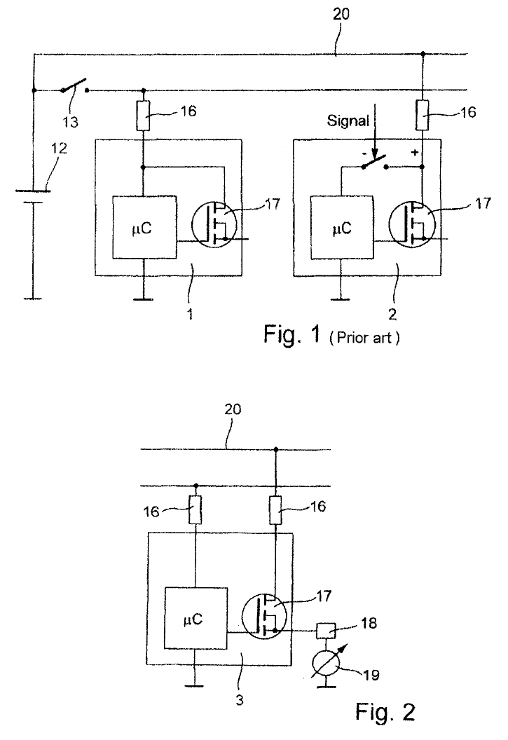

FIG. 1 illustrates two known variants of the power supply circuit in control units according to the prior art, which have already been described above, together with the prior art.

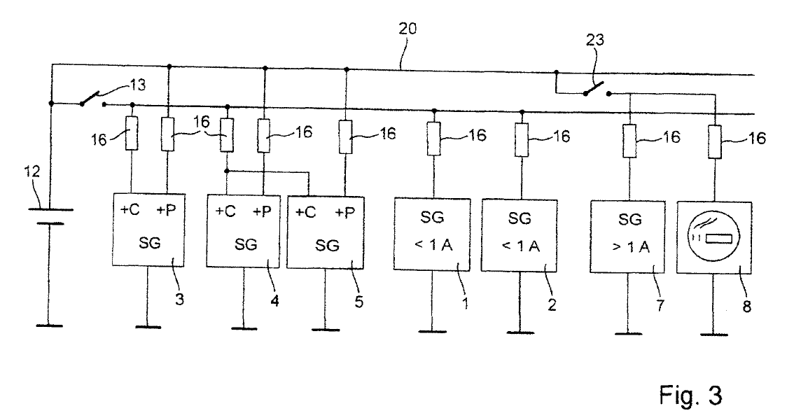

FIG. 2 illustrates a control unit 3 with microcomputer μC and power switch 17. The power supply circuit is fed by an accumulator 12 (FIG. 3). The power supply terminal +P is connected in an electrically conductive fashion via a power supply line 20 (continuously supplied with power) and a fuse 16, while the first power supply terminal +C is connected via a fuse 16 to a power supply line 30, which can be switched by the quiescent current switch 13 (FIG. 3) to the accumulator 12.

According to the invention, a plurality of similar control units are connected to the power supply circuit and in each case the first power supply terminals +C are connected jointly to the accumulator 12 via the quiescent current switch 13. Since the first power supply terminal +C is coupled to the respective voltage regulators of the control units, which in turn supply current to the microcomputer μC, it is necessary to place all the microcomputers jointly in the safe quiescent state, by means of the quiescent current switch 13, after the databus system has been powered down.

On the other hand, when corresponding power switches 17 (for example MOSFET transistors) are used, the output stages 18 and the actuators 19 do not have to run via the quiescent current switch, as the internal resistance in the switched MOSFET power switch is very high, so that the power losses are in the micro-ampere range. For this reason, it is not necessary also to switch off the power supply line 20 via the quiescent current switch. According to the invention, this provides a considerable advantage in that the quiescent current needs only be configured to switch off the microcomputer power supply via the power supply terminal +C. The power supply line 20 on which the powered actuators are supplied with power is then not switched off by means of a quiescent current relay, as is the case for the quiescent current switch 13. In this way, according to the present invention it is possible to achieve a considerable cost saving since the quiescent current switch places only part of the load (specifically, the microcomputers) in the quiescent state. The actuators 19 of a plurality of similar control units are switched off via the internal power switches of the control units, and the power losses are low in this case because of the MOSFET transistors which are used.

FIG. 3 illustrates a first device such as could be used according to the present invention for controlling components of a vehicle. In the exemplary control unit architecture, classic control units 1 and 2 are connected via the quiescent current switch 13 to the accumulator 12. In each case, fuses 16 are connected into the power supply line, and the control units are each connected to ground. Both control units 1 and 2 are what are referred to as low current control units which actuate sensors and actuators with a low power drain. The latter can be conducted in a conventional way via the quiescent current switch 13, since the quiescent current relay 13 is scarcely additionally loaded by the low current control units. For this reason, the quiescent current switch 13 can continue to be configured with a relatively low quiescent current capacitance. On the other hand, the control units 7 and 8 are high current control units and are therefore connected via respective fuses 16 to the power supply line 20 which cannot be switched, and a separate switch 23 is provided in order to disconnect the latter from the power supply circuit independently of the other control units.

In addition to these classic control units, in FIG. 3 control units according to the present invention are also connected. The control unit 3 has two power supply terminals +C and +P according to the invention, which power supply terminals +C and +P are each connected via fuses 16 both to the power supply circuit 20 which cannot be switched, and to the power supply line which can be switched by means of the quiescent current switch 13 for the microcomputers μC.

The two other control units 4 and 5 according to the invention likewise have first power supply terminals +C and second power supply terminals +P for the load currents. The low current power supply terminals +C of the control units 4 and 5 can be led, in a bundled form, via a fuse 16 to the power supply line to the quiescent current switch 13 and to the accumulator 12. As a result, fuses 16 for a plurality of control units can be dispensed with on the low current side. In the control units 4 and 5, the structure according to the invention is shown by means of the voltage supply terminal +C for the power supply of the microcomputers and the power supply terminal +P for the load current of the actuators 19 which are led via the load switch 17 which is internal in the control unit. As a result of the separation of the microcomputer power supply terminals +C and load current supply terminals +P, the dimensioning of the quiescent current switch relay 13 can result in a low current switching capacity, which provides considerable savings in terms of the quiescent current switch 13.

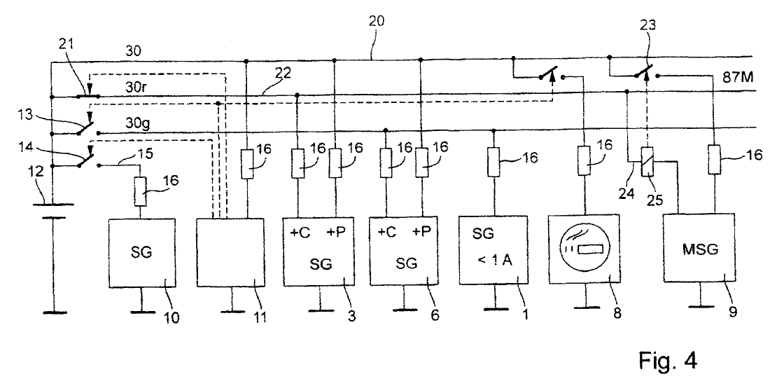

FIG. 4 illustrates a second alternative of the device according to the invention with a power supply circuit. Compared to the example in FIG. 3, a reset power supply line 22 with a reset switch 21 are introduced. The reset switch 21 can be provided here as what is referred to as a normally closed switch that is actuated by means of the on-board vehicle power system management control unit 11. If a failure occurs in the control unit system, specific control units 3 and 9, which are connected to the reset supply line 22, can be deactivated by means of the reset switch 21, in which case the microcomputers are automatically placed in a defined reset state and powered up again. The on-board vehicle power system management control unit 11 is configured here in such a way that these reset states can be triggered only in predefined parking situations of the motor vehicle.

The on-board vehicle power system management control unit 11 also actuates the ignition/starter switch 14, which is activated electronically in modern vehicles. Control units 10 are arranged on this ignition/starter switch 14 and they are powered up when the engine starts and powered down when the engine is switched off. The parking control unit is affected by this, for example, since its function is no longer necessary after the internal combustion engine has been switched off. The reset control units 3 and 9 include, for example, the engine control unit MSG which is connected to the power supply line 20 and therefore to the accumulator 12 via the fuse 16 and the central switch on the power supply line 87M. The power supply line 24 which is connected to the reset power supply line 22 can be switched off by means of a relay 25, which ensures that at the same time the switch for the load circuit 23 is opened.

The other reset-enabled control unit 3 can be, for example, the passenger compartment control unit which, in the event of malfunctions, can be placed in a defined fashion in the reset state. The control unit 6 is illustrated by way of example of a group of similar control units according to the invention with two power supply terminals +C and +P, which group makes possible the inventive advantage of the relatively low dimensioning of the quiescent current relay switch 13. As a result, the considerable cost effect during mass production of means of transportation can be achieved when the quiescent current switch 13 is configured.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-6. (canceled)

7. A device for controlling components of a vehicle, said device comprising:
a plurality of control units, each of which includes a microcomputer; and
a power supply circuit for said control units; wherein,
a first side of the power supply circuit is connected to an accumulator and a second side of the power supply circuit is connected to the control units;
a first group of the control units can be switched off by means of a quiescent current switch which is connected directly into a current path between the accumulator and the control units;
a second group of the control units is connected to the accumulator via the ignition/starter switch;
an on-board vehicle power system controller is continuously supplied with power via the accumulator;
said on-board vehicle power system controller actuates the quiescent current switch and the ignition/starter switch for the switching process;
at least one of said control units has two power supply terminals;
a first one of said power supply terminals is connected to the voltage regulator for the microcomputer of said at least one of said control units and to the accumulator, via the quiescent current switch;
a second one of the power supply terminal is connected to the accumulator via a fuse;
each microcomputer is supplied with energy via the first power supply terminal;
in each control unit, a power switch is supplied with power via the second power supply terminal in order to supply energy to an actuator; and
the on-board vehicle power system controller controls the quiescent current switch in order to deactivate the microcomputers, while the power switches of the same control unit are supplied with power.

8. The device as claimed in claim 7, wherein the microcomputers and the power switches are arranged inside the control units;
the power switches and the microcomputers are arranged on a printed circuit board;
a control electrode of the power switches is actuatable by the microcomputer; and
the load current terminals are led out separately from the control unit via an interface.

9. The device as claimed in claim 7, wherein:
the on-board vehicle power system controller activates the quiescent current switch in order to deactivate the microcomputers at a predetermined time; and
the on-board vehicle power system controller activates a reset switch which places control units connected to the reset supply line in a predefined reset mode.

10. The device as claimed in claim 1, wherein:
a plurality of first power supply terminals are led from various control units to the quiescent current switch via a common fuse.

11. The device as claimed in claim 7, wherein:
a control unit is placed in a reset mode via the reset supply line; and
a coupling means simultaneously interrupts the power supply line by means of a switch, so that the actuated actuator is simultaneously deactivated.

12. The device as claimed in claim 7, wherein the first power supply terminal comprises a low current terminal for currents of less than 1 ampere, to supply power to logic circuits, microcomputers and low current loads.
